(19) United States
(12) Patent Application Publication
(10) Pub. No.: US 2026/0149111 A1
(43) Pub. Date: May 28, 2026

(54) MULTILAYER BODY FOR SEALING MATERIALS, SEALING MATERIAL AND BATTERY

(71) Applicant: UCHIYAMA MANUFACTURING CORP., Okayama (JP)

(72) Inventors: Otone ESUMI, Okayama (JP); Yuji YASUFUKU, Okayama (JP); Takami KAWABATA, Okayama (JP)

(21) Appl. No.: 19/123,463

(22) PCT Filed: Oct. 24, 2023
(86) PCT No.: PCT/JP2023/038244

§ 371 Date: Apr. 23, 2025

(30) Foreign Application Priority Data
Nov. 9, 2022 (JP) 2022-179883

(51) Int. Cl. H01M 50/293; H01M 10/658; H01M 50/204

(52) U.S. Cl. CPC H01M 50/293; H01M 10/658; H01M 50/204

(57) ABSTRACT

There is provided a laminate for sealing materials having flame retardancy higher than in the past. A laminate for sealing materials (10, 10a) according to an aspect of the present invention includes a first layer (1) comtaining a flame retardant silicone rubber compound and a second layer (2, 2a, 2b) which is a coating containing flame retardant, in which the flame retardant is an inorganic flame retardant which is not a metal hydroxide.

### TECHNICAL FIELD

The present invention relates to a laminate for sealing materials, a sealing material, and a battery.

### BACKGROUND ART

In the past, a technology to dispose a flame retardant layer on a substrate in order to impart flame retardancy to an article has been proposed (for example, see PATENT LITERATURES 1 and 2).

### CITATION LIST

### Patent Literature

PATENT LITERATURE 1: JP-A-2016-141728
PATENT LITERATURE 2: JP-A-2009-001012

### SUMMARY OF INVENTION

### Problems to be Solved by Invention

Silicone rubber used for a sealing material may also be required to have flame retardancy depending on its use. The present inventors conducted research to find that existing silicone rubber has room for further improvement from the viewpoint of flame retardancy.

An object of an aspect of the present invention is to provide a laminate for sealing materials having flame retardancy higher than in the past.

### Solution to Problems

A laminate for sealing materials according to an aspect of the present invention includes: a first layer containing a flame retardant silicone rubber compound; and a second layer which is a coating containing a flame retardant, in which the flame retardant is an inorganic flame retardant which is not a metal hydroxide.

### Effects of Invention

According to an aspect of the present invention, there is provided a laminate for sealing materials having flame retardancy higher than in the past.

### BRIEF DESCRIPTION OF DRAWINGS

FIG. 1 is a schematic view illustrating an example of an outline structure of a laminate for sealing materials according to an aspect of the present invention.

FIG. 2 is a schematic view illustrating another example of an outline structure of a laminate for sealing materials according to an aspect of the present invention.

FIG. 3 is a schematic view illustrating an example of a battery using a sealing material according to an aspect of the present invention.

### DESCRIPTION OF EMBODIMENTS

Hereinafter, embodiments of the present invention will be described in detail. However, the present invention is not limited to the following embodiments, which can be variously modified within the described scope. An embodiment in which the technical measures disclosed in different embodiments are appropriately combined is also contained in the technical scope of the present invention.

In the present specification, “A to B” representing a numerical value range denotes “A or more and B or less”.

### <<1. Laminate for Sealing Materials>>

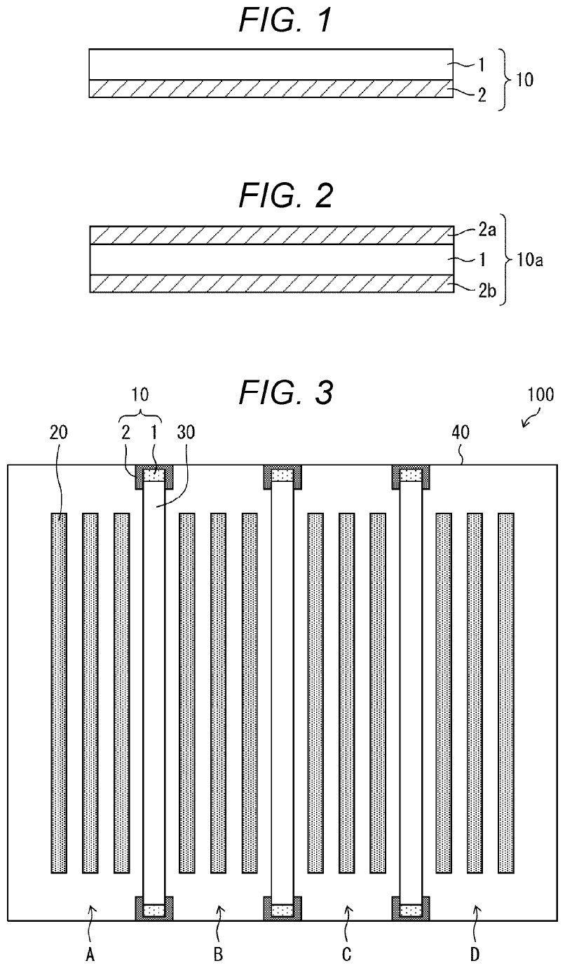

FIG. 1 is a schematic view illustrating an example of an outline structure of a laminate for sealing materials according to an aspect of the present invention. A laminate for sealing materials 10 (sealing material 10) includes a first layer 1 and a second layer 2. Hereinafter, the second layer 2 and the first layer 1 will be sequentially described.

### [1.1. Second Layer]

The second layer is a coating containing a flame retardant. In an embodiment, the second layer contains a flame retardant and a matrix resin.

### (Flame Retardant)

The flame retardant is an inorganic flame retardant which is not a metal hydroxide. Examples of such a flame retardant include a fiber-based flame retardant, a thermally expandable graphite, an antimony oxide-based flame retardant, and a metal oxide. In the present specification, a phosphorus-based flame retardant and a bromine-based flame retardant are classified into an organic flame retardant and not contained in an inorganic flame retardant. In an embodiment, the flame retardant is one or more selected from the group consisting of a thermally expandable graphite and a fiber-based flame retardant.

The thermally expandable graphite refers to a graphite having a property of expanding by heating. The thermally expandable graphite has a structure in which an interlayer insert such as sulfuric acid is inserted between layers of graphite crystals. When the thermally expandable graphite is heated, the interlayer insert is decomposed to become gas, so that the thermally expandable graphite becomes an expanded graphite having a significantly expanded volume. The expanded graphite is non-flammable and also serves as a heat insulating material.

In an embodiment, the expansion rate when the thermally expandable graphite is heated is 100 times or more or 200 times or more. In an embodiment, the temperature at which the thermally expandable graphite starts to expand is 150° C. or higher or 200° C. or higher.

The fiber-based flame retardant refers to a flame retardant in a fibrous form. In the present specification, the “fibrous form” means a shape having an aspect ratio (length/diameter) of 3 or more.

The lower limit of the average fiber length of the fiber-based flame retardant is preferably 50 μm or more, more preferably 70 μm or more, and further preferably 100 μm or more. The upper limit of the average fiber length of the fiber-based flame retardant is preferably 1500 μm or less, more preferably 1000 μm or less, and further preferably 800 jun or less. The lower limit of the average diameter of the fiber-based flame retardant is preferably 0.05 μm or more, more preferably 0.1 μm or more, further preferably 0.15 μm or more, and particularly preferably 0.2 μm or more. The upper limit of the average diameter of the fiber-based flame retardant is preferably 10.0 μm or less, more preferably 5.0 μm or less, further preferably 3.0 μm or less, and particularly preferably 1.0 μm or less. The lower limit of the aspect ratio is preferably $ or more, more preferably 50 or more, further preferably 100 or more, and particularly preferably 150 or more. The upper limit of the aspect ratio is preferably 5000 or less, more preferably 4000 or less, further preferably 1000 or less, particularly preferably 500 or less, and further more preferably 250 or less.

Examples of the fiber-based flame retardant include artificial mineral fiber, natural mineral fiber, and synthetic organic fiber. Examples of the artificial mineral fiber include rock wool, stone wool, slag wool, mineral wool, glass wool, mineral glass wool, alkali earth silicate wool (AES wool), and alumina fiber. Examples of the natural mineral fiber include wollastonite and potassium titanate fiber. An example of the synthetic organic fiber is aramid fiber. Among these, artificial mineral fiber is preferable. The artificial mineral fiber is preferably one or more selected from the group consisting of AES wool, rock wool, and alumina fiber. In an embodiment, the fiber-based flame retardant is an inorganic substance. In an embodiment, the fiber-based flame retardant is not asbestos.

### (Matrix Resin)

The matrix resin is a resin to serve as the matrix of the second layer. In the second layer, the flame retardant material is preferably dispersed uniformly in the matrix resin.

The matrix resin is, for example, a resin obtained by curing a curable oligomer or polymer. The curable oligomer or polymer is, for example, cured by reacting with moisture, heat, or energy rays (such as ultraviolet rays). Examples of the matrix resin include a silicone resin, an acrylic resin, an epoxy resin, a phenolic resin, and a urethane resin. Among these, a silicone resin is preferable from the viewpoint of heat resistance and flame retardancy.

### (Chemical Composition of Second Layer)

The lower limit of the content ratio of the flame retardant in the second layer with respect to the weight of the second layer is preferably 5 wt % or more, more preferably 10 wt % or more, and further preferably 20 wt % or more. The upper limit of the content ratio of the flame retardant in the second layer with respect to the weight of the second layer is preferably 70 wt % or less, more preferably 60 wt % or less, and further preferably 50 wt % or less.

The lower limit of the content ratio of the matrix resin in the second layer with respect to the weight of the second layer is preferably $0 wt % or more, more preferably 60 w (% or more, and further preferably 70 wt % or more. The upper limit of the content ratio of the matrix resin in the second layer with respect to the weight of the second layer is preferably 95 wt % or less, more preferably 90 wt % or less, and further preferably 80 wt % or less.

### (Coating Liquid)

In an embodiment, the second layer is a layer obtained by curing a coating liquid. In an embodiment, the coating liquid contains a flame retardant and a coating base. The flame retardant is as described above. The coating base is a composition containing a curable oligomer or polymer and forms a matrix resin when cured. Examples of the curable oligomer or polymer include a silicone oligomer or polymer, an acryl oligomer or polymer, and a phenol oligomer or polymer. Among these, a silicone oligomer or polymer is preferable from the viewpoint of heat resistance and flame retardancy.

As the curable silicone oligomer or polymer, a commercially available product may be used. Examples of such a commercially available product include DOWSIL™ RSN-0217 Flake Resin, RSN-0220 Flake Resin, RSN-0233 Flake Resin, RSN-0249 Flake Resin, RSN-0255 Flake Resin, and RSN-6018 Intermediate (all manufactured by Dow Toray Co., Ltd.); KR-220L, KR-220LP. KR-242A, KR-271, KR-282, KR-300, KR-311, ES-100 IN, ES-1002T, ES-1023, X-41-1610, KR-5206, KR-5234, KR-5235, KR-2038, KR-165, KR-169, and KR-9076 (all manufactured by Shin-Etsu Chemical Co., Ltd.); and SILRES (R) KX, HK46, MSE100, 610, RENS0, REN60, REN70M, REN80, REN100, MPSOE, MPF52E, and 604 (all manufactured by Wacker Asahikasei Silicone Co., Ltd.).

The lower limit of the viscosity of the coating liquid is preferably 0.01 Pa·s or more, more preferably 0.05 Pa·s or more, and further preferably 0.1 Pa·s or more. The upper limit of the viscosity of the coating liquid is preferably 100 Pa·s or less, more preferably 50 Pa·s or less, and further preferably 10 Pa·s or less from the viewpoint of coating properties. The viscosity of the coating liquid can be adjusted by selecting a curable oligomer or polymer, selecting a solvent, blending a viscosity modifier, or the like.

### [1.2. First Layer]

The first layer contains a flame retardant silicone rubber compound.

### (Flame Retardant Silicone Rubber Compound)

A flame retardant silicone rubber compound is a flame retardancy-imparted silicone rubber composition which is obtained by blending various additives to silicone rubber. In an embodiment, the flame retardant silicone rubber compound has a UL94 standard of HB or higher. That is, the flame retardant silicone rubber compound has a UL94 standard of 5VA, 5VB, V-O, V-1, V-2, or HB. In an embodiment, the flame retardant silicone rubber compound has a UL94 standard of V-0 or higher. That is, the flame retardant silicone rubber compound has a UL94 standard of 5VA, 5VB, or V-0. In an embodiment, the flame retardant silicone rubber compound has a UL94 standard of V-0.

The UL94 standard is a standard for evaluating the flame retardancy of a plastic product and is widely adopted worldwide. The classes of the UL94 standard include, in the descending order of flame retardancy, 5VA, 5VB, V-0, V-1, V-2, and HB. Since the test method of UL94 standard is known by persons skilled in the art, descriptions thereof will be omitted.

Examples of the silicone rubber contained in the flame retardant silicone rubber compound include methyl silicone rubber, vinyl methyl silicone rubber, phenyl methyl silicone rubber, and fluorinated silicone rubber. These silicone rubbers may be contained individually or in combination of two or more. In an embodiment, the flame retardant silicone rubber compound contains vinyl methyl silicone rubber. Examples of the additive contained in the flame retardant silicone rubber compound include platinum, a platinum compound, an iron oxide, a triazole-based compound, and an aluminum hydroxide. These additives may be contained individually or in combination of two or more. Regarding a silicone rubber compound that falls under the second flame retardant silicone rubber compound, many commercial products are available, and many related patent literatures exist. Therefore, descriptions of the detailed chemical composition of the flame retardant silicone rubber compound will be omitted.

Examples of the flame retardant silicone rubber compound having a UL94 standard of V-0 or higher include SILASTIC™ SH502U. SH502U A/B, and SH1447 U A (all manufactured by Dow Toray Co., Ltd.); KE-5620W-U, KE-5620BL-U, KE-5612E-U, KE-3494, KE3490, KE3467, KE-4890, KE-40RTV, KE-1831, KE-1867, KE-1891, KE-1204-LTV, KE-1292, KE-1800, and KE-1802 (all manufactured by Shin-Etsu Chemical Co., Ltd.); ELASTOSIL (R) LR 3011/50 FR, LR 3001/55 FR, LR 3001/60 FR, and LR 3170/40 (all manufactured by Wacker Asahikasei Silicone Co., Ltd.); and TSE2186U, TSE2183U, TSE2187U, TSE2184U, TCM5406U. XE20-A7016 (all manufactured by Momentive Performance Materials Japan LLC). Examples of the flame retardant silicone rubber compound having a UL94 standard of HB to V-1 include XIAMETER™ RBB-6630-30, RBB-6640-40, RBB-6650-50, RBB-6660-60, RBB-6670-70, RBB-6680-80, and RBB-6671-70 (all manufactured by Dow Toray Co., Ltd.); SILASTIC™ SE 4704 U, SE 470S U, SE 4706 U, SE 4708 U, DY 32-6014 U, DY 32-7040 U, DY 32-8013 U. SRX 495 U, and DY 32-502 U (all manufactured by Dow Toray Co., Ltd.); KE-5634-U, KE-941-U, KE-951-U, KE-961-U, KE-971-U, KE-981-U, and KE-97IT-U (all manufactured by Shin-Etsu Chemical Co., Ltd.); ELASTOSIL (R) LR 3003/(x), LR 3004/(y), LR 3005/(y), LR 3065/(e), and LR 3092/65 BK (all manufactured by Wacker Asahikasei Silicone Co., Ltd.); and TSE221-3U, TSE221-4U, TSE221-5U, TSE221-6U, TSE221-7U, TSE221-SU, TSE2277U, XE20-523-4U, XE20-523-5U, TSE2181U, TCM5417U, TSE2911U, and TSE2971U (all manufactured by Momentive Performance Materials Japan LLC).

Examples of patent literatures disclosing a silicone rubber compound that falls under the flame retardant silicone rubber compound include JP-A-2004-149693, JP-A-2006-182911, and JP-A-2009-144024.

The first layer may contain a component other than the above-described components. Examples of such a component include a curing agent and various additives.

The curing agent is a component that imparts rubber elasticity to the first layer. Persons skilled in the art can appropriately select a curing agent depending on the reaction mechanism for imparting rubber elasticity. Examples of the reaction mechanism by a curing agent include a crosslinking reaction, a condensation reaction, and an addition reaction.

In the case of imparting rubber elasticity through an addition reaction, organohydrogen polysiloxane and a platinum-based catalyst can be used. Organohydrogen polysiloxane is a polyorganosiloxane in which the average number of hydrogen atoms bound to a silicon atom per molecule is two or more.

The flame retardant silicone rubber compound may contain oil. The oil is preferably silicone oil and more preferably modified silicone oil. Silicone oil refers to an oil having polyorganosiloxane as the main component. Modified silicone oil refers to a silicone oil in which methyl groups contained in dimethyl silicone oil are partly substituted with other functional groups. Examples of the modified silicone oil include amino modified silicone oil, epoxy modified silicone oil, carboxyl modified silicone oil, carbinol modified silicone oil, (meth)acrylic modified silicone oil, mercapto modified silicone oil, phenol modified silicone oil, polyether modified silicone oil, methylstyryl modified silicone oil, alkyl modified silicone oil, higher fatty acid ester modified silicone oil, higher alkoxy modified silicone oil, fluorine modified silicone oil, and aralkyl modified silicone oil. Modified silicone oil includes non-reactive modified silicone oil and reactive modified silicone oil. Among these, non-reactive modified silicone oil is preferable.

The first layer may contain various additives which are known in the technical field. Examples of such additives include reinforcing fillers (such as silica, diatomaceous earth, quartz powder, mica, and titanium oxide); extender fillers (such as diatomaceous earth, quartz powder, mica, clay, glass beads, and aluminum oxide); heat resistance improvers (such as carbon black, red iron oxide, alkali metal oxide, and alkaline earth metal oxide); and pigments.

### (Chemical Composition of First Layer)

The lower limit of the content ratio of the flame retardant silicone rubber compound with respect to the total weight of the first layer is preferably 70 wt % or more, more preferably 80 wt % or more, and further preferably 90 wt % or more. The upper limit of the content ratio of the flame retardant silicone rubber compound can be, for example, 99.9 w (% or less.

When the first layer contains a rubber component other than silicone rubber, the ratio of the silicone rubber with respect to the entirety of the rubber components is preferably 50 wt % or more, more preferably 70 wt % or more, and further preferably 90 wt % or more. In an embodiment, the first layer does not contain a rubber component other than silicone rubber. Examples of the rubber component other than silicone rubber include fluorine rubber (FKM), natural rubber (NR), styrene-butadiene rubber (SBR), isoprene rubber (IR), butadiene rubber (BR), chloroprene rubber (CR), acrylonitrile butadiene rubber (NBR), butyl rubber (IIR), ethylene·propylene rubber (EPM), ethylene-propylene diene rubber (EPDM), urethane rubber (U), ethylene acrylic rubber (AEM), and acrylic rubber (ACM).

The lower limit of the content of the oil in the first layer with respect to the total weight of the first layer is preferably 0.1 wt % or more, more preferably 0.3 wt % or more, and further preferably 0.5 wt % or more. When the content of the oil is less than 0.1 wt %, processability may deteriorate. The upper limit of the content of the oil in the first layer with respect to the total weight of the first layer is preferably 15 wt % or less, more preferably 10 wt % or less, and further preferably 5 wt % or less. When the content of the oil exceeds 15 mass %, excessive softness or bleeding may occur.

In an embodiment, the first layer does not substantially contain a fiber-based flame retardant. The content of the fiber-based flame retardant in the first layer, when the content of the flame retardant silicone rubber compound is 100 parts by weight, is preferably 1 part by weight or less, more preferably 0.5 part by weight or less, and further preferably 0.1 part by weight or less. In an embodiment, the first layer does not contain the fiber-based flame retardant.

Persons skilled in the art can appropriately determine the blending amounts of other components in the first layer according to the common technical knowledge. For example, the content of the curing agent, when the content of the flame retardant silicone rubber compound is 100 parts by weight, can be 0.2 to 5.0 parts by weight.

### [1.3. Structure and Physical Properties of Laminate for Sealing Materials]

A laminate for sealing materials according to an aspect of the present invention includes a first layer and a second layer. In an embodiment, the laminate for sealing materials includes one first layer and one second layer. This embodiment is a laminate for sealing materials 10 in which a second layer 2 is laminated to one surface of a first layer 1 as illustrated in FIG. 1. In an embodiment, the laminate for sealing materials includes one first layer and two second layers. This embodiment is a laminate for sealing materials 10a in which second layers 2a and 2b are individually disposed to both surfaces of a first layer 1 as illustrated in FIG. 2. In the laminate for sealing materials 10a, the chemical compositions of the second layer 2a and the second layer 2b may be the same or different.

The Shore A hardness of the laminate for sealing materials is preferably 85 or less and more preferably 80 or less. When the Shore A hardness is within the above-described range, it can be said that the laminate for sealing materials has softness suitable as a sealing material. In the present specification, the Shore A hardness is measured with the surface of the second layer as a measurement surface by a type A durometer in accordance with JIS K6253. It is noted that the measurement target for the Shore A hardness of the silicone rubber laminate is a silicone rubber laminate after curing in an ordinary state (a state of being not subjected to a flammability test).

The laminate for sealing materials according to an aspect of the present invention has flame retardancy higher than that of only a silicone rubber composition (that is, only the first layer). In the present specification, “having high flame retardancy” means that one or more, preferably both, of the following two conditions are satisfied. The flame retardancy can be evaluated by a flammability test. For the method of performing a flammability test, see Examples of the present application.
(Condition 1) Smoke occurrence time is delayed, or smoke does not occur.
(Condition 2) Flame occurrence time is delayed, or flame does not occur.

### <<2. Sealing Material and Battery>>

A sealing material according to an aspect of the present invention includes the above-described laminate for sealing materials. In the present specification, the sealing material means a molded product used by being disposed between two or more members. The two or more members may be members which change in their relative position or may be members which do not relatively move. The sealing material has a function of, for example, sealing the movement of fluid (gas, liquid, or a mixture thereof).

The use of the sealing material is not particularly limited. With high flame retardancy, a sealing material according to an embodiment of the present invention is preferably used for a product required to have flame retardancy. Examples of such a product include a battery, a vehicle, a housing material, a household appliance, and a mobile terminal.

Hereinafter, a use example when the sealing material according to an embodiment of the present invention is applied to a battery will be described with reference to FIG. 3. A battery 100 includes a sealing material 10 (a laminate for sealing materials 10), a cell 20, a heat insulating material 30, and a container 40. The battery 100 is configured to draw power from two or more cells 20 (from twelve cells 20 in FIG. 3). It is noted that in FIG. 3, a member for drawing power from the cells 20 is omitted. A specific example of the battery 100 is a nonaqueous electrolyte secondary battery (such as a lithium ion secondary battery).

The sealing material 10 is the sealing material according to an aspect of the present invention. The cell 20 is a power generation element in which a positive electrode, a negative electrode, a separator, an electrolytic solution, and the like are packaged. The heat insulating material 30 is a member that prevents the transmission of generated heat of the cell 20. The container 40 is a member that houses the sealing material 10, the cell 20, and the heat insulating material 30.

The inside of the container 40 is divided by the heat insulating material 30 into two or more compartments. In FIG. 3, the inside of the container 40 is divided into four compartments of compartment A, compartment B, compartment C, and compartment D. Two or more cells 20 are divided into two or more of the two or more compartments. In FIG. 3, the cells 20 are disposed in all the four compartments of compartments A to D. Regarding this, a compartment without the cell 20 disposed may exist. The sealing material 10 is disposed to fill a void between the heat insulating material 30 and the container 40. Further, the sealing material 10 is disposed such that the first layer 1 is in contact with the heat insulating material 30. The first layer 1 is softer than the second layer 2, so that it also can follow the positional change of the heat insulating material 30 and improves in sealing properties. On the other hand, the second layer 2 is disposed to block the first layer 1 from spaces A to D, so that the first layer 1 can be prevented from being brought into contact with flame.

For example, when the cell 20 disposed in compartment A fails and is fired, the sealing material 10 and the heat insulating material 30 prevent the spread of fire into compartment B. The sealing material 10, which is the sealing material according to an aspect of the present invention, has flame retardancy higher than that of an existing sealing material and further maintains elongation after burning. Therefore, the battery 100 has safety higher than that of an existing battery.

### <<3. Production Method of Laminate for Sealing Materials>>

A production method of the laminate for sealing materials according to an aspect of the present invention includes a step of providing a first layer containing a flame retardant silicone rubber compound, a step of providing a coating liquid containing a flame retardant, and a step of coating at least a part of a surface of the first layer with the coating liquid and then curing the coating liquid.

The first layer can be produced by curing a flame retardant silicone rubber compound. For example, the first layer can be produced by kneading and curing a composition containing the components described in section [1.2]. The kneading of the components can be performed using a kneading machine. Examples of the kneading machine include an open roll, a kneader, a planetary mixer, a Banbury mixer, and an extruder. The kneading temperature may be 25 to 200° C. The kneading time may be 1 minute to 1 hour. The curing temperature may be 25 to 200° C. The curing time may be 10 seconds to 120 minutes. In addition, the cured first layer may be further subjected to secondary curing. The secondary curing temperature may be 25 to 250° C. The secondary curing time may be 30 minutes to 4 hours.

The coating liquid can be prepared by mixing the coating base and the flame retardant described in section [1.1]. The mixing of the components can be performed using a mixer. Examples of the mixer include a planetary mixer, a triple roll mill, and a mill mixer. The suitable viscosity of the coating liquid is as described in section [1.1].

The prepared coating liquid is applied to at least a part of a surface of the first layer and then cured, so that the second layer is formed on the surface of the first layer. For example, the coating liquid is reacted with moisture, heat, energy rays (such as ultraviolet rays), and the like thereby to be cured.

### 4. CONCLUSION

The present invention includes the following configurations.

<1>

A laminate for sealing materials (10, 10a) including:
a first layer (1) containing a flame retardant silicone rubber compound; and
a second layer (2, 2a, 2b) which is a coating containing a flame retardant,
in which the flame retardant is an inorganic flame retardant which is not a metal hydroxide.

The laminate for sealing materials (10, 10a) according to <1>,
in which a content of the flame retardant in the second layer (2, 2a, 2b) is 5 to 70 wt %.
   <3>

The laminate for sealing materials (10, 10a) according to <1> or <2>,
in which the second layer (2, 2a, 2b) is a layer obtained by curing a coating liquid.

The laminate for sealing materials (10, 10a) according to <3>,
in which the coating liquid has a viscosity of 0.1 to 10 Pa·s.
   <5>

The laminate for sealing materials (10, 10a) according to <1> or <2>
in which the flame retardant is one or more selected from the group consisting of a thermally expandable graphite and a fiber-based flame retardant.
   <6>

The laminate for sealing materials (10, 10a) according to any one of <1> to <5>, in which
the second layer (2, 2a, 2b) contains a fiber-based flame retardant, and
the fiber-based flame retardant contains one or more selected from the group consisting of artificial mineral fiber, natural mineral fiber, and synthetic organic fiber.
   <7>

The laminate for sealing materials (10, 10a) according to <65, in which
the fiber-based flame retardant contains the artificial mineral fiber, and
the artificial mineral fiber contains one or more selected from the group consisting of AES wool, rock wool, and alumina fiber.
   <8>

The laminate for sealing materials (10, 10a) according to <1>,
in which the flame retardant silicone rubber compound has a UL94 standard of V-0 or higher.

The laminate for sealing materials (10, 10a) according to <1>,
in which a content ratio of the flame retardant silicone rubber compound in the first layer (1) is 70 wt % or more.
   <10>

A sealing material (10, 10a) including
the laminate for sealing materials (10, 10a) according to any one of <1> to <9>.
   <11>

A battery (100) including:
two or more cells (20),
a heat insulating material (30);
a container (40); and
the sealing material (10, 10a) according to <10>, in which
the two or more cells (20), the heat insulating material (30), and the sealing material (10, 10a) are housed in the container (40),
   the heat insulating material (30) is disposed to divide an inside of the container (40) into two or more compartments,
the two or more cells (20) are divided into two or more of the two or more compartments, and
the sealing material (10, 10a) is disposed such that the sealing material (10, 10a) seals a gap between the heat insulating material (30) and the container (40) and such that the first layer is in contact with the heat insulating material (30).
   <12>

A production method of a laminate for sealing materials (10, 10a) including:
a step of providing a first layer (1) containing a flame retardant silicone rubber compound;
a step of providing a coating liquid containing a flame retardant; and
a step of coating at least a part of a surface of the first layer (1) with the coating liquid and then curing the coating liquid,
in which the flame retardant is an inorganic flame retardant which is not a metal hydroxide.
   <13>

The production method according to <12>,
in which the coating liquid has a viscosity of 0.1 to 10 Pa·s.

### EXAMPLES

Hereinafter, an embodiment of the present invention will be more specifically described by Examples. However, the present invention is not limited to these Examples.

### [Used Materials]

Flame retardant silicone rubber compound
Flame retardant silicone rubber compound (KE-5612E-U, Shin-Etsu Chemical Co., Ltd., vinyl methyl silicone rubber-based compound, UL94 standard: V-0)
Curing agent
Curing agent (C-3, Shin-Etsu Chemical Co., Ltd., dicumyl peroxide)
Coating base
Coating base (KR-2038, Shin-Etsu Chemical Co., Ltd., flame retardant silicone coating)
Flame retardant
Thermally expandable graphite (EXP-80$220), FUJIKOKUEN Co., Ltd.)
Fiber-based flame retardant (RS490ELS-Roxul 1000, Lapinus, rock wool)
Phosphorus-based flame retardant (Fireguard FCX-210, Teijin Limited, organic flame retardant)
Metal hydroxide (aluminum hydroxide)

### Examples 1 and 2

According to the following procedure, a sealing material including a vulcanized rubber sheet (the first layer) and a coating layer (the second layer) was prepared. This sealing material serves as a material for preparing a test piece in the later-described test.
1. The components of the first layer described in Table 1 were kneaded by an open roll. The kneading temperature was 20 to 100° C.″. The kneading time was 10 to 30 minutes.
2. With the obtained kneaded product, an unvulcanized rubber sheet as the first layer was prepared.
3. The unvulcanized rubber sheet as the first layer was put in a sheet mold having a depth of 2 mm and subjected to press vulcanization at 165° C. for 10 minutes.
4. The vulcanized rubber sheet as the first layer was subjected to secondary vulcanization at 200° C. for 4 hours. In this manner, a vulcanized rubber sheet (thickness: 2 mm) as the first layer was obtained,
5. The components of the second layer described in Table 1 were mixed to prepare a coating liquid.
6. The entirety of one surface of the vulcanized rubber sheet as the first layer obtained in step 4 was coated with the coating liquid obtained in step 5. The film thickness of the coating layer was 0.1 mm to 2.0 mm.
7. The coating product obtained in step 6 was heated in an oven to cure a coating layer as the second layer. In this manner, a sealing material including the vulcanized rubber sheet and the coating layer was prepared.

### Comparative Example 1

According to the procedure of steps 1 to 4 of Examples, a sealing member as a vulcanized rubber sheet without a coating layer laminated was prepared. This sealing material serves as a material for preparing a test piece in the later-described test.

### Comparative Example 2

According to the procedure of Examples, a sealing material including a coating layer containing a phosphorus-based flame retardant was prepared. This sealing material serves as a material for preparing a test piece in the later-described test.

### Comparative Example 3

According to the procedure of Examples, a sealing material including a coating layer containing a metal hydroxide as a flame retardant was prepared. This sealing material serves as a material for preparing a test piece in the later-described test.

### [Test Method]

A test piece was subjected to a flammability test to evaluate flame retardancy. A specific procedure is as described below.
1. The sealing material prepared in each of Examples or Comparative Examples was cut out into a sheet having a width of 15 mm and a length of 100 mm to obtain a test piece.
2. The test piece was fixed to a jig, and the flame of a burner was adjusted such that the temperature at the burning site was 800° C.
3. Flame was applied to the test piece for 2 minutes. The smoke occurrence time (sec) and the flame occurrence time (sec), when the flame application time was 0 second, were recorded. The recorded results are illustrated in Table 1.

For the test piece after subjected to a flammability test, presence or absence of deformation was visually determined, and evaluated according to the following four levels. The evaluation results are illustrated in Table 1.
4 . . . Deformation does not exist, or deformation is minor.
3 . . . Deformation is small.
2 . . . Deformation is moderate.
1 . . . Deformation is large.

Furthermore, for the test piece after subjected to a flammability test, appearance was visually determined, and evaluated according to the following four levels. The evaluation results are illustrated in in Table 1.
4 . . . Very good. Only whitening has occurred without cracking, or cracking is minute.
3 . . . Good, Small to moderate cracking has occurred.
2 . . . Average. Large cracking has occurred.
1 . . . Poor. Multiple fractures, peelings, breaks, crushes, and the like have occurred.

TABLE 1

| | | | | | Comparative | Comparative | Comparative |
|---|---|---|---|---|---|---|---|
| | | | Example 1 | Example 2 | Example 1 | Example 2 | Example 3 |
| First layer | Flame retardant silicone rubber | Parts by weight | 100.0 | 100.0 | 100.0 | 100.0 | 100.0 |
| | compound | | | | | | |
| | Curing agent | Parts by weight | 0.5 | 0.5 | 0.5 | 0.5 | 0.5 |
| Second layer | Coating base | Parts by weight | 100.0 | 100.0 | 100.0 | 100.0 | 100.0 |
| | Thermally expandable graphite | Parts by weight | 30.0 | — | — | — | — |
| | Fiber-based flame retardant | Parts by weight | — | 30.0 | — | — | — |
| | Phosphorus-based flame retardant | Parts by weight | — | — | — | 50.0 | — |
| | Metal hydroxide | Parts by weight | — | — | — | — | 30.0 |
| Evaluation | Smoke occurrence time | Sec | —*1 | 45 | 15 | 5 | 45 |
| | Flame occurrence time | Sec | —*1 | 45 | 15 | 5 | —*1 |

| | | | | | |
|---|---|---|---|---|---|
| Deformation | 4 | 3 | 2 | 2 | 1 |
| Appearance | 4*2 | 4 | 1 | 1 | 3 |

*1No smoke or flame had occurred at 120 sec after start of flame application.
*2Since the coating layer had expanded and scattered, appearance of the vulcanized rubber sheet from which the coating layer was stripped was evaluated.

### [Results]

When Examples 1 and 2 are compared to Comparative Example 1, it is understood that the provision of the second layer has improved flame retardancy. When Examples 1 and the 2 are compared to Comparative Example 2, it is understood that the use of the inorganic flame retardant as a flame retardant has improved flame retardancy.

More specifically, the smoke occurrence time was later in Example 2 than in Comparative Example 1 and Comparative Example 2, and smoke did not occur until after the end of the test in Example 1. The flame occurrence time is also later in Example 2 than in Comparative Example 1 and Comparative Example 2, and flame did not occur until after the end of the test in Example 1.

Further, the comparison on the deformation of the test piece after buming demonstrated that the characteristics were better in Examples 1 and 2 than in Comparative Examples 1 to 3. The comparison on the appearance of the test piece after burning demonstrated that the characteristics were better in Examples 1 and 2 than in Comparative Examples 1 and 2.

Regarding the test piece after burning, the coating layer of the sealing material according to Example 1 had expanded, produced soot, and scattered, but had no observed damage inside the vulcanized rubber sheet. In the sealing material according to Example 2, curing was observed inside the vulcanized rubber sheet. The sealing material according to Comparative Example 2 burned with flame. Moreover, the coating layer extremely deteriorated, and damage was also observed inside the vulcanized rubber sheet. In the sealing material according to Comparative Example 3, deformation after the flammability test was extremely large, and the test piece had totally bended when unsupported. Further, in the sealing material according to Comparative Example 3, curing was observed inside the vulcanized rubber sheet.

### INDUSTRIAL APPLICABILITY

The present invention can be utilized for, for example, a sealing material for batteries and others.

### DESCRIPTION OF REFERENCE SIGNS

1: First layer
2, 2a, 2b: Second layer
10, 10a: Laminate for sealing materials (sealing material)
20: Cell
30: Heat insulating material
40: Container
100: Battery

1. A laminate for sealing materials comprising:
a first layer containing a flame retardant silicone rubber compound; and
a second layer which is a coating containing a flame retardant,
wherein the flame retardant is an inorganic flame retardant which is not a metal hydroxide.

2. The laminate for sealing materials according to claim 1,
wherein a content of the flame retardant in the second layer is 5 to 70 wt %.

3. The laminate for sealing materials according to claim 1,
wherein the second layer is a layer obtained by curing a coating liquid.

4. The laminate for sealing materials according to claim 3,
wherein the coating liquid has a viscosity of 0.1 to 10 Pa·s.

5. The laminate for sealing materials according to claim 1,
wherein the flame retardant is one or more selected from the group consisting of a thermally expandable graphite and a fiber-based flame retardant.

6. The laminate for sealing materials according to claim 5, wherein
the second layer contains a fiber-based flame retardant, and
the fiber-based flame retardant contains one or more selected from the group consisting of artificial mineral fiber, natural mineral fiber, and synthetic organic fiber.

7. The laminate for sealing materials according to claim 6, wherein
the fiber-based flame retardant contains the artificial mineral fiber, and
the artificial mineral fiber contains one or more selected from the group consisting of AES wool, rock wool, and alumina fiber.

8. The laminate for sealing materials according to claim 1,
wherein the flame retardant silicone rubber compound has a UL94 standard of V-0 or higher.

9. The laminate for sealing materials according to claim 1,
wherein a content ratio of the flame retardant silicone rubber compound in the first layer is 70 wt % or more.

10. A sealing material comprising
the laminate for sealing materials according to claim 1.

11. A battery comprising:
two or more cells;
a heat insulating material;
a container; and
the sealing material according to claim 10, wherein
the two or more cells, the heat insulating material, and the sealing material are housed in the container,
the heat insulating material is disposed to divide an inside of the container into two or more compartments,
the two or more cells are divided into two or more of the two or more compartments, and
the sealing material is disposed such that the sealing material seals a gap between the heat insulating material and the container and such that the first layer is in contact with the heat insulating material.

12. A production method of a laminate for sealing materials comprising:
a step of providing a first layer containing a flame retardant silicone rubber compound;
a step of providing a coating liquid containing a flame retardant; and
a step of coating at least a part of a surface of the first layer with the coating liquid and then curing the coating liquid,
wherein the flame retardant is an inorganic flame retardant which is not a metal hydroxide.

13. The production method according to claim 12,
wherein the coating liquid has a viscosity of 0.1 to 10 Pa·s.
